(19) United States
(12) Patent Application Publication
(10) Pub. No.: US 2016/0254833 A1
(43) Pub. Date: Sep. 1, 2016

(54) LISTENING DEVICE AND METHOD OF PROVIDING AUXILIARY POWER TO A WIRELESS DEVICE

(71) Applicant: Leigh Mitchell Rothschild, Miami, FL (US)

(72) Inventor: Leigh Mitchell Rothschild, Miami, FL (US)

(73) Assignee: Ariel Inventions, LLC, MIAMI, FL (US)

(21) Appl. No.: 14/983,607

(22) Filed: Dec. 30, 2015

Related U.S. Application Data
(60) Provisional application No. 62/120,889, filed on Feb. 26, 2015.

(51) Int. Cl. H04B 1/3883; H04M 1/725

(52) U.S. Cl. CPC H04B 1/3883; H04M 1/72527

(57) ABSTRACT

A listening device including an energy source configured to supply power to at least one rechargeable portable device. The energy source is rechargeable and is housed within the listening device.

### CROSS-REFERENCE TO RELATED APPLICATION

This application claims the priority to U.S. provisional application No. 62/120,889 filed on Feb. 26, 2015 which is hereby incorporated herein in its entirety by reference.

### BACKGROUND

Unless otherwise indicated herein, the materials described in this section are not prior art to the claims in this application and are not admitted to be prior art by inclusion in this section.

The subject matter in general relates to rechargeable portable devices, more particularly, but not exclusively, the subject matter relates to providing auxiliary power to the rechargeable portable devices.

Rechargeable portable devices such as mobile phones, smart phones, tablets and laptops, among others, are common place. Over the years, dependency of users over such devices has increased substantially, and so has the usage time of such devices. Rechargeable portable devices manufactures have attempted to address the requirement of longer usage time by attempting to incorporate longer lasting rechargeable battery into these devices.

Although batteries powering rechargeable portable devices today last much longer than they used to a decade back, as an example, the requirement for longer lasting batteries has not been completely addressed. Even today users yearn for rechargeable portable devices that can provide longer battery life. A major problem is that these devices frequently run out of charge before the user is finished using the device for the day. On several occasions these device completely run out of power at some point during usage. When these devices run out of power, it can be a major problem that can result in calls being terminated, services being shut down, data lost or transactions not being completed.

Rechargeable portable devices manufactures on the other hand face the challenge of striking a balance between size of the rechargeable battery they provide in the devices, form factor of the rechargeable portable devices and cost of the devices, among others, to make the rechargeable portable devices attractive to consumers.

Conventionally, users attempt to overcome the shortcoming being discussed by carrying portable standalone power supply devices, which are typically referred to as power banks. These power banks house internal rechargeable batteries whose size may vary based on the voltage it is designed to supply. Typically, the size of the internal batteries increases with the voltage. A power bank connects to the rechargeable portable device via a cable to charge the rechargeable portable device. Users are either compelled to manage with the battery life offered by their rechargeable portable devices or carry such power banks, which they would not have carried if not to be prepared for a contingency of the rechargeable portable devices running out of charge at an undesirable time.

In light of the foregoing discussion, there is a need for an improved technique for providing auxiliary power to the rechargeable portable devices.

### SUMMARY

According to an aspect of the present disclosure, a listening device is provided. The listening device includes an energy source configured to supply power to at least one rechargeable portable device.

According to another aspect of the present disclosure, a portable device is provided. The portable device includes a first rechargeable energy source housed by the portable device. The portable device is configured to be coupled to a listening device. The listening device houses a second rechargeable energy source. The first rechargeable energy source is configured to be charged by the second rechargeable source.

According to yet another aspect of the present disclosure, a method of providing auxiliary power to a wireless device is provided. The method includes housing an energy source within a listening device, coupling the listening device to the wireless device and transmitting energy from the energy source to the wireless device.

These and other features and advantages will become more clear when the drawings as well as the detailed description are taken into consideration.

### BRIEF DESCRIPTION OF THE DRAWINGS

Embodiments are illustrated by way of example and not limitation in the Figures of the accompanying drawings, in which like references indicate similar elements and in which:

FIG. 1A is an isometric view of an exemplary listening device 100a configured to charge a rechargeable portable device;

FIG. 1B is an exploded view of the listening device 100a;

FIG. 1C illustrates the listening device 100a connected to a rechargeable portable device 10 and a primary energy source 12;

FIG. 1D illustrates an embodiment of a listening device 100b in which a single cable 124 is configured to enable charging of a rechargeable portable device 10a and communication of data/audio signal between the rechargeable portable device 10a and the listening device 100b;

FIG. 1E illustrates yet another embodiment of a listening device 100c in which provision 126 for concealing cables is provided;

FIG. 1F illustrates still another embodiment of a listening device 100d in which an energy source 108d is housed by a headband 104 of the listening device 100d; and

FIG. 2 is a block diagram of an exemplary energy management module 106 of a listening device.

### DETAILED DESCRIPTION

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

An embodiment provides a listening device such as a headphone that is capable of charging a battery of a portable device, such as a smart phone or a tablet. The listening device accommodates a rechargeable energy source that supplies energy to the battery of a portable device. The listening device is configured to be coupled with the portable device via a cable. The cable transmits power/energy from the energy source to the rechargeable portable device.

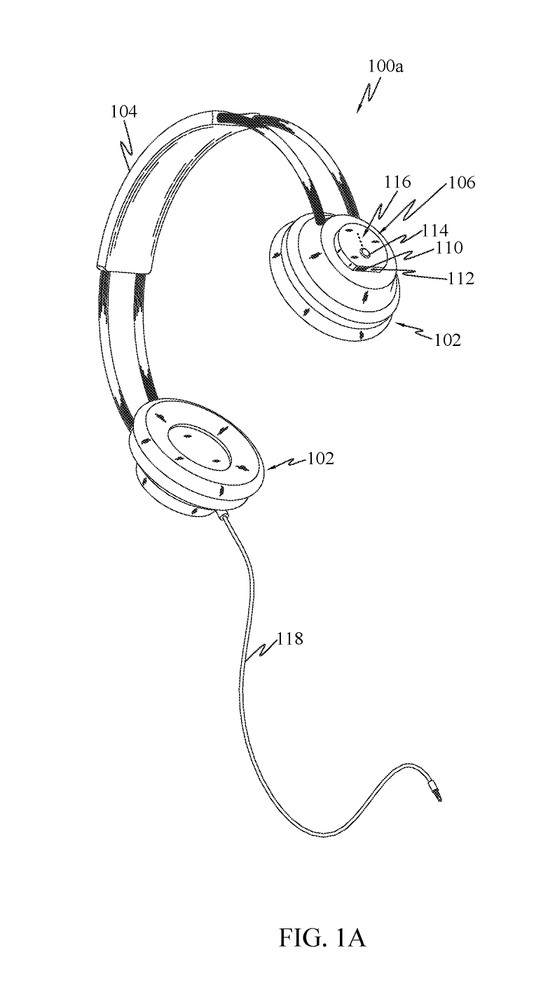

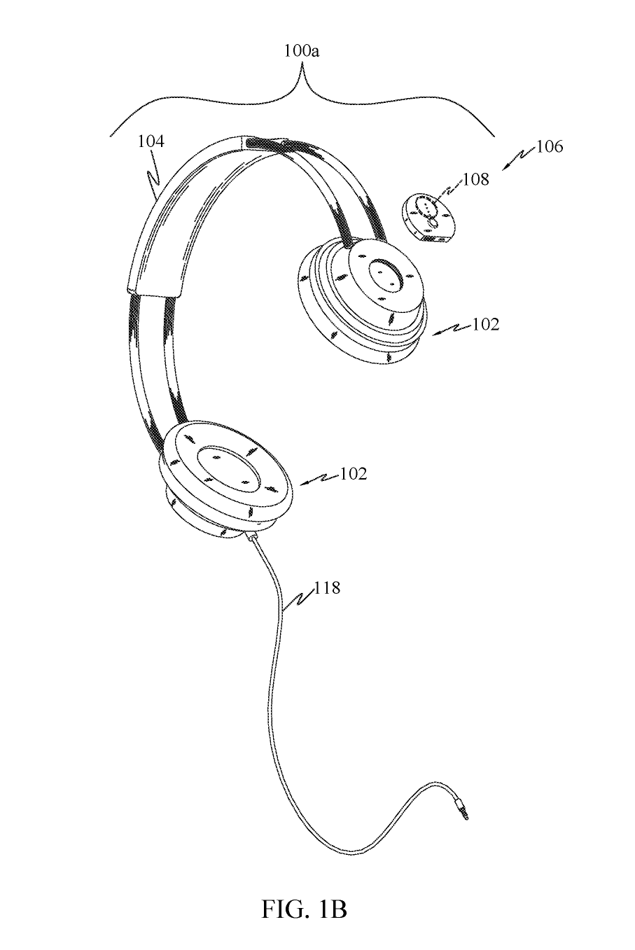

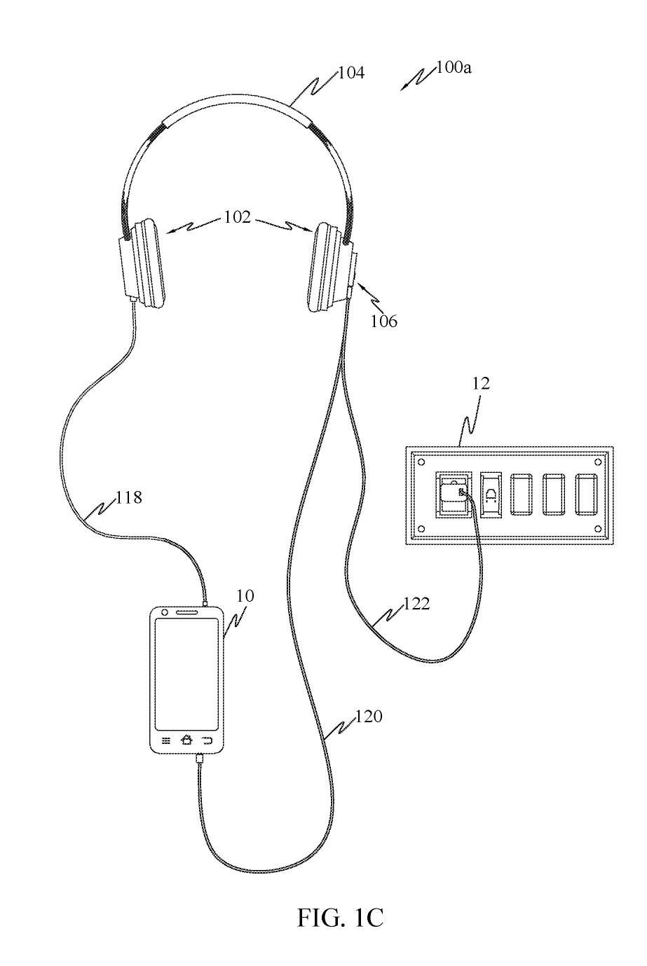

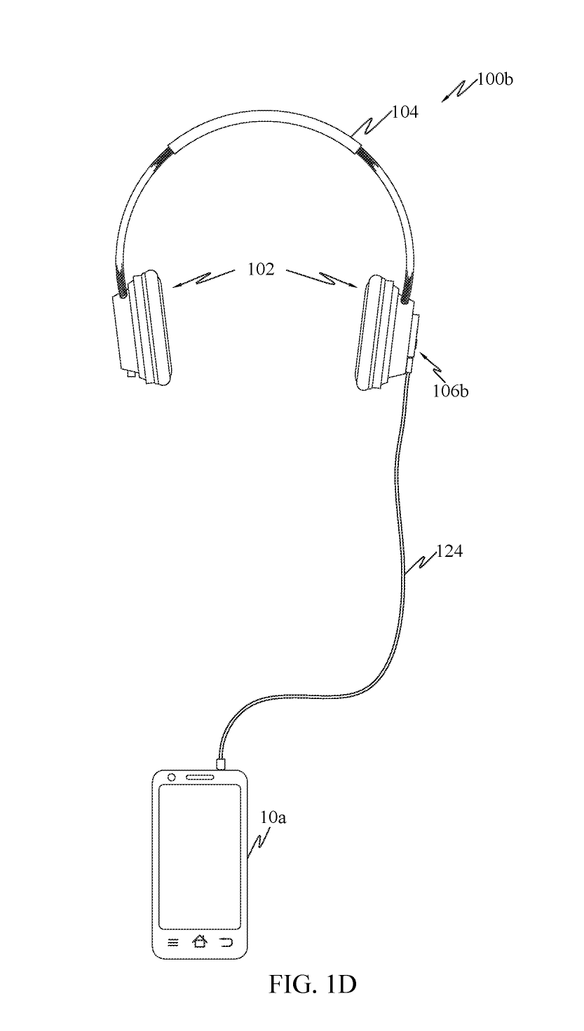

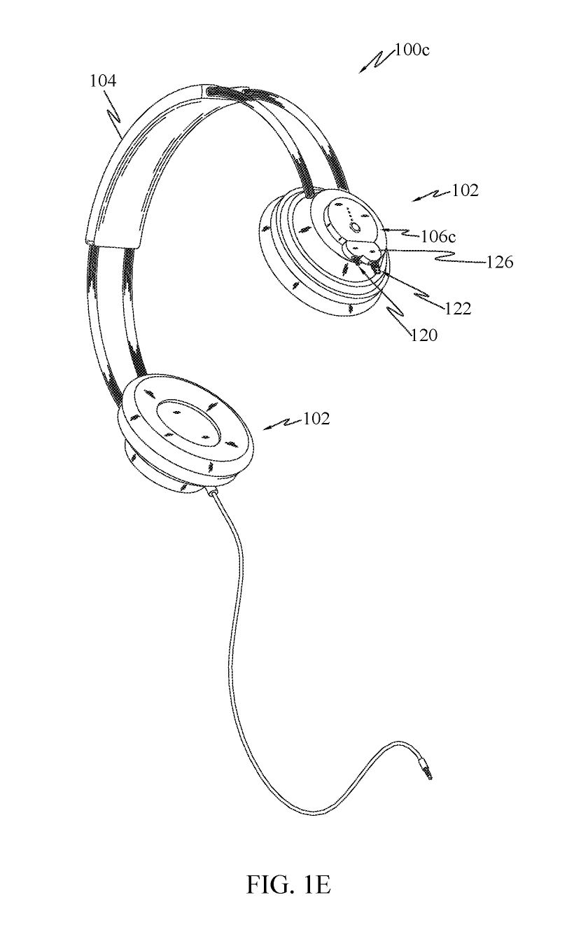

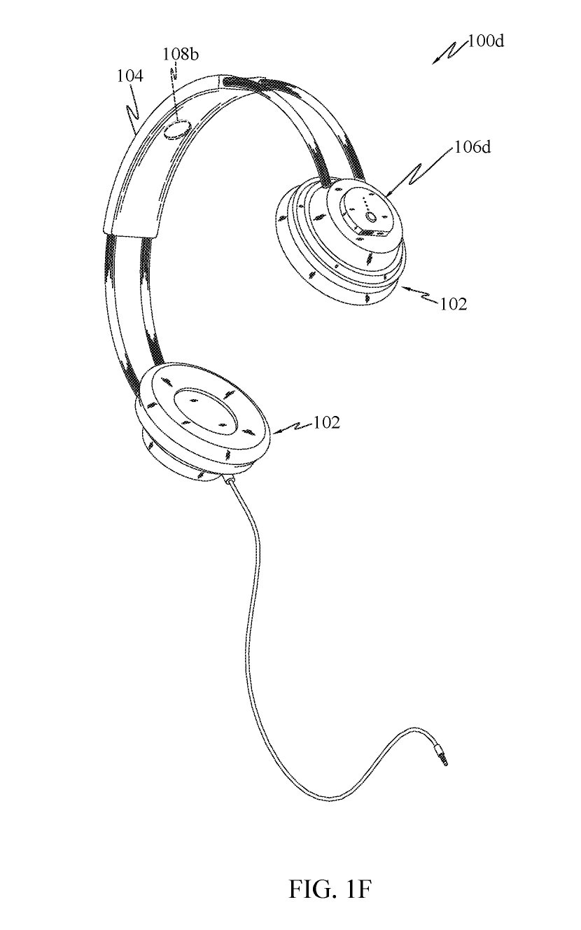

Referring to the figures, and more particularly to FIG. 1A-1C, an exemplary listening device 100a is illustrated. The listening device 100a, as an example can be a headphone that delivers audio output. The listening device 100a includes at least one speaker assembly 102. In the present example a pair of speaker assemblies 102 is illustrated. The speaker assemblies 102 may enclose the ears of the user and may provide noise cancellation functionality. The speaker assembly 102 may be referred to as ear piece. The listening device 100a may further include a head band 104. The head band 104 may connect the speaker assemblies 102. The head band 104 may be an adjustable headband to adjust the fit to the user's head.

The listening device 100a accommodates at least one energy management module 106. The energy management module 106 includes an energy source 108 (illustrated in FIG. 1B), one or more first connector port 110, a second connector port 112, a switch 114 and an indicator 116.

The listening device 100a further includes a first cable 118. The first cable 118 is configured to be connected to a rechargeable portable device 10. The first cable 118 is capable of communicating audio signals from the rechargeable portable device 10 to the listening device 100a so that audio is played by the speaker assemblies 102. One end of the first cable 118 may be connected to an audio jack of the rechargeable portable device 10.

In an embodiment, the first cable 118 is capable of communicating audio signals/data/instruction between the rechargeable portable device 10 and the listening device 100a. Examples of the rechargeable portable device 10 include, but not limited to, smart phone and tablet. The rechargeable portable device 10, in an embodiment, is a device that includes a rechargeable energy source and is capable of communicating at least audio signals to the listening device 100a.

In an embodiment, the audio signals are communicated between the rechargeable portable device 10 and the listening device 100a wirelessly.

The listening device 100a may further include a second cable 120. The second cable may connect the energy management module 106 of the listening device 100a to the rechargeable portable device 10. One end of the second cable 120 may be coupled with the first connector port 110 of the energy management module 106 and a second end of the of the second cable 120 may be received by a charging port of the rechargeable portable device 10. The second cable 120 is capable of transmitting energy from the energy source 108 of the energy management module 106 to the rechargeable portable device 10 to recharge the rechargeable portable device 10.

In an embodiment, more than one first connector port 110 may be provided to enable simultaneously charging of more than one rechargeable portable device.

In an embodiment, energy from the energy source 108 of the energy management module 106 to the rechargeable portable device 10 is transmitted wirelessly. Current examples of wireless charging include inductive charging. Other types of wireless charging may include infrared transmission of power and radio waves such as microwave transmission.

The listening device 110a may further include a third cable 122. The third cable 122 may connect the energy management module 106 of the listening device 100a to a primary energy source 12. The primary energy source 12 as an example may be a wall power source. In an embodiment, the primary energy source 12 is a source that is cable of transmitting energy to the energy management module 106 to recharge the energy source 108 of the energy management module 106. One end of the third cable 122 may be coupled with the second connector port 112 of the energy management module 106 and a second end of the third cable 122 may coupled with the primary energy source 12. The third cable 122 is capable of transmitting energy from the primary energy source 12 to the energy management module 106 to recharge the energy source 108 of the energy management module 106.

In an embodiment, energy from the primary energy source 12 to the energy management module 106 to recharge the energy source 108 is transmitted wirelessly. Current examples of wireless charging include inductive charging. Other types of wireless charging may include infrared transmission of power and radio waves such as microwave transmission.

The energy management module 106, and thereby the energy source 108, is accommodated by the listening device 100a. In an embodiment, the energy management module 106 is readily engageable with and disengageable from the listening device 100a by a user. In an example implementation (as illustrated at least in FIG. 1B) the energy management module 106 snap fits with one of the speaker assemblies 102. The energy management module 106 may be made readily engageable and disengageable by way of threaded fit between the energy management module 106 and the listening device 100a. Other example means of making the energy management module 106 readily engageable and disengageable include, but not limited to, slot and groove mechanism and hook and loop mechanism.

In an embodiment, the energy management module 106 or at least a part of it may be received within an enclosure of the speaker assembly 102. In this embodiment, at least the part of the energy management module 106 which is received within the enclosure of the speaker assembly 102 may not be readily engageable with and disengageable from the listening device 100a.

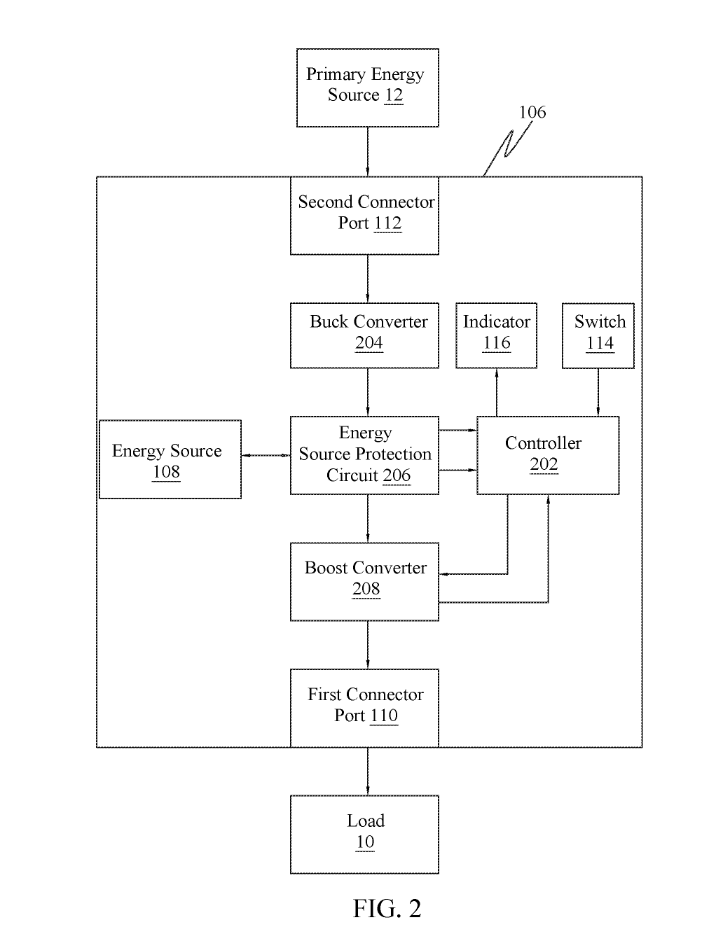

Referring also to FIG. 2, in an embodiment, the energy management module 106 may include a controller 202, a buck converter 204, an energy source protection circuit 206 and a boost converter 208, in addition to the energy source 108, the first connector port 110, the second connector port 112, the switch 114 and the indicator 116.

The second connector port 112, which can be a Micro-USB connector, may be used to connect the primary energy source 12 to charge the energy source 108. The first connector port 110 may be used to connect to the rechargeable portable device 10 for charging. Input voltage from the second connector port 112 may be fed to the buck converter 204. The buck converter 204 may convert, as an example, 5V input voltage into either a constant current or constant voltage to charge the energy source 108. The energy source protection circuit 206 may be connected to the energy source 108. The energy source protection circuit 206 may monitor the energy source 10 voltage and current. The energy source protection circuit 206 may disconnect the energy source 108 to protect the energy source 108. The energy source 108 may be disconnected, as an example, upon detection of over charge, over discharge, over load and short circuit. The boost converter 208 may step up the 3.0V to 4.2V energy source 108 voltage to 5V that may be required to charge the rechargeable portable device 10. The controller 202 may turn on the boost converter 208 when the switch 114 is pressed on. The switch 114 may be operable to either enable or disable transmission of energy from the energy source 108 to the rechargeable portable device 10. The controller 202 may measure the energy source 108 voltage and control the indicator 116 to indicate state of charge. The indicator 116 may be controlled to indicate whether the energy source 108 has to be recharged. The indicator may be in the form of one or more of visual, audio and haptic indicator. The controller 202 may turn off the boost converter 208 when the rechargeable portable device 10 stops drawing current.

In an embodiment, energy management module 106 or the listening device 100a is configured to receive command from the rechargeable portable device 10 to either transmit or stop transmitting energy from the energy source 108 to the rechargeable portable device 10. Further, based on the command, the controller 202 may enable or disable feeding of energy from the energy source 108 to the rechargeable portable device 10.

In an embodiment, the rechargeable portable device 10 is configured to terminate charging of the rechargeable energy source of the portable device 10 by the energy source 108.

The energy source 202 as an example can be a battery. Examples of types of batteries include, but are not limited to, Alkaline, Lithium-ion, Lead-acid, Nickel-cadmium, Nickel-metal hydride, Sealed Lead Acid, Sodium-ion and Zinc bromine.

In an embodiment, the primary energy source may be photo-voltaic cells. The photo-voltaic cells may be electrically/electronically connected to the energy source 108 to charge the energy source 108. The photo-voltaic cells, as an example, may be arranged on the exterior of the listening device.

In another embodiment, the primary energy source may be piezoelectric composite. The piezoelectric composite may be connected to the energy source 108 to charge the energy source 108. The piezoelectric composite, as an example, may be arranged in the interior of the listening device. In an embodiment, the piezoelectric composite is arranged to at least harvest vibrations produced in the speaker assembly/assemblies of the listening device, due to the audio being played, to generate electric charge.

Referring to FIG. 1D, an embodiment of a listening device 100b is configured to be engaged with a cable 124. The cable 124 is configured to be connected to the rechargeable portable device 10a. The cable 124 is capable of communicating at least audio signals between the rechargeable portable device 10 and the listening device 100b. The cable 124 is also capable of transmitting energy from the energy source of an energy management module 106b to the rechargeable portable device 10a, thereby reducing the number of cables required to charge the rechargeable portable device 10a and communicate data/audio signals. Such cables are generally referred to as 2-in-1 charger and audio cable or 2-in-1 charger and data cable.

Referring to FIG. 1E, an embodiment of a listening device 100c include a cable retractor 126. The cable retractor 126 may be a spring loaded cable retractor. The cable retractor 126 may be coupled to the energy management module 106c. The cable retractor 126 enables the second cable 120 to be operable to conceal at least a portion of the second cable 120 when not in use and reveal at least a preferred length of the second cable 120 to enable connection with the rechargeable portable device 10. The cable retractor 126 further enables the third cable 122 to be operable to conceal at least a portion of the third cable 122 when not in use and reveal at least a preferred length of the third cable 122 to enable connection with the primary energy source 12.

In an embodiment, the cable retractor may be such that at least one of one or more cables externally engageable to the energy management module is enabled to be operable to conceal at least a portion of the cable so enabled when not in use and reveal at least a preferred length of the cable so enabled for use.

Referring to FIG. 1F, in an embodiment of a listening device 100d includes at least one energy source 108b that is housed by the headband 104 of the listening device 100d. The energy source 108b may be connected to the rest of the energy management module 106 electrically via connection running through the headband 104.

The example embodiments described herein may be implemented in an operating environment comprising software installed on a processing system, in hardware, or in a combination of software and hardware.

Although embodiments have been described with reference to specific example embodiments, it will be evident that various modifications and changes may be made to these embodiments without departing from the scope of the claims. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A listening device comprising an energy source configured to supply power to at least one rechargeable portable device.

2. The listening device of claim 1, wherein the energy source is rechargeable.

3. The listening device of claim 1, wherein the rechargeable energy source is accommodated by the listening device.

4. The listening device of claim 1, further comprising a cable configured to be connected to the rechargeable portable device, wherein,
the cable communicates audio signals between the rechargeable portable device and the listening device; and
the cable optionally transmits energy from the energy source to the rechargeable portable device.

5. The listening device of claim 1, further comprising a first cable and a second cable, wherein,
the first cable is configured to be connected to the rechargeable portable device, wherein the first cable communicates audio signals between the rechargeable portable device and the listening device; and
the second cable is configured to be connected to the rechargeable portable device, wherein the second cable optionally transmits energy from the energy source to the rechargeable portable device.

6. The listening device of claim 5, wherein the second cable is operable to conceal at least a portion of the second cable when not in use and reveal at least a preferred length of the second cable to enable connection with the rechargeable portable device.

7. The listening device of claim 1, wherein energy from the energy source is transmitted wirelessly to the rechargeable portable device.

8. The listening device of claim 1, wherein the energy source is connected to a connector port, wherein the connector port is configured to be coupled with a cable that is connectable to a primary energy source to recharge the energy source of the listening device.

9. The listening device of claim 8, wherein the cable is operable to conceal at least a portion of the cable when not in use and reveal at least a preferred length of the cable to enable connection with the primary energy source.

10. The listening device of claim 1, further comprising an indicator to indicate charge status of the energy source.

11. The listening device of claim 1, further comprising an indicator to indicate whether the energy source has to be recharged.

12. The listening device of claim 1, further comprising a switch operable to either enable or disable transmission of energy from the energy source to the rechargeable portable device.

13. The listening device of claim 1, further configured to receive command from the rechargeable portable device to either transmit or stop transmitting energy from the energy source to the rechargeable portable device.

14. The listening device of claim 1, further comprising a pair of ear piece, wherein the energy source is accommodated by at least one ear piece among the pair.

15. The listening device of claim 1, further comprising a headband, wherein the energy source is housed by the headband.

16. A portable device comprising a first rechargeable energy source housed by the portable device, wherein the portable device is configured to be coupled to a listening device, wherein the listening device houses a second rechargeable energy source, wherein the first rechargeable energy source is configured to be charged by the second rechargeable source.

17. The portable device of claim 16 further configured to communicate command to the listening device to transmit energy from the second rechargeable energy source to the first rechargeable energy source.

18. The portable device of claim 16 further configured to communicate command to the listening device to stop transmitting energy from the second rechargeable energy source to the first rechargeable energy source.

19. The portable device of claim 16 further configured to terminate charging of the first rechargeable energy source by the second rechargeable energy source.

20. A method of providing auxiliary power to a wireless device, the method comprising:
housing an energy source within a listening device;
coupling the listening device to the wireless device; and
transmitting energy from the energy source to the wireless device.

21. A system for providing auxiliary power to a wireless device, the system configured to:
accommodate an energy source within a listening device;
transmit energy from the energy source to the wireless device; and
transmit audio signals from the wireless device to the listening device, wherein audio corresponding to the audio signal is played by the listening device.

22. The system of claim 21, wherein the audio signals are transmitted wirelessly.

23. The system of claim 21, wherein the energy is transmitted wirelessly.

24. The system of claim 21, wherein the audio signals and the energy are transmitted via a cable.

25. The system of claim 21, wherein the audio signals and the energy are transmitted simultaneously.
